(19) United States
(12) Patent Application Publication
(10) Pub. No.: US 2007/0028772 A1
(43) Pub. Date: Feb. 8, 2007

(54) Method and system for purifying a gas

(76) Inventors: Ravi Jain, Bridgewater, NJ (US); YuDong Chen, Bridgewater, NJ (US)

Correspondence Address: THE BOC GROUP, INC., 575 MOUNTAIN AVENUE, MURRAY HILL, NJ, 07974-2064, US

(21) Appl. No.: 11/500,080

(22) Filed: Aug. 7, 2006

Related U.S. Application Data
(60) Provisional application No. 60/706,326, filed on Aug. 8, 2005.

(51) Int. Cl. B01D 53/02

(52) U.S. Cl. 95/135

(57) ABSTRACT

The present invention provides for a method and system for purifying carbon dioxide. Moisture, oxygenates, aromatics and some sulfur species are removed from the carbon dioxide by adsorption with some of the impurities being removed by adsorption on a Y zeolite.

### FIELD OF THE INVENTION

The present invention provides a method and system for purifying and analyzing a gas. In particular, this invention provides a method and system for purifying a carbon dioxide gas stream from impurities containing moisture, oxygenates and aromatics.

### BACKGROUND OF THE INVENTION

Carbon dioxide is used in a number of industrial and domestic applications, many of which require the carbon dioxide to be free from various impurities. Unfortunately, carbon dioxide obtained from natural sources such as gas wells, chemical processes, fermentation processes or produced in industry, particularly carbon dioxide produced by the combustion of hydrocarbon products, often contains impurity levels of sulfur compounds such as carbonyl sulfide (COS) and hydrogen sulfide (H₂S) as well as oxygenates such as acetaldehydes and alcohols as well as aromatics such as benzene. When the carbon dioxide is intended for use in an application that requires the carbon dioxide to be of high purity, such as in the manufacture and cleaning of foodstuffs and beverage carbonation, medical products and electronic devices, the sulfur compounds and other hydrocarbon impurities contained in the gas stream must be removed to very low levels prior to use. The level of impurity removal required varies according to the application of carbon dioxide. For example for beverage application the total sulfur level in carbon dioxide (CO₂) ideally should be below 0.1 ppm and aromatic hydrocarbons need to be below 0.02 ppm. For electronic cleaning applications removal of heavy hydrocarbons to below 0.1 ppm is required.

Various methods for removing sulfur compounds and hydrocarbon impurities from gases such as carbon dioxide are known. For example, U.S. Pat. No. 4,332,781, issued to Lieder et al., discloses the removal of COS and H₂S from a gas stream by first removing the H₂S from the hydrocarbon gas stream by contacting the gas stream with an aqueous solution of a regenerable oxidizing reactant, which may be a polyvalent metallic ion, such as iron, vanadium, copper, etc., to produce a COS-containing gas stream and an aqueous mixture containing sulfur and reduced reactant. The COS in the gas stream is subsequently hydrolyzed to CO₂ and H₂S by contacting the gas stream with water and a suitable hydrolysis catalyst, such as nickel, platinum, palladium, etc., after which the H₂S and, if desired, the CO₂ are removed. This step can be accomplished by the earlier described H₂S removal step or by absorption. The above-described process involves the use of cumbersome and costly equipment and liquid-based systems which require considerable attention and may result in the introduction of undesirable compounds, such as water vapor, into the carbon dioxide product.

U.S. Pat. Nos. 5,858,068 and 6,099,619 describe the use of a silver exchanged faujasite and an MFI-type molecular sieve for the removal of sulfur, oxygen and other impurities from carbon dioxide intended for food-related use. U.S. Pat. No. 5,674,463 describes the use of hydrolysis and reaction with metal oxides such as ferric oxide for the removal of carbonyl sulfide and hydrogen sulfide impurities from carbon dioxide.

It is known to directly remove sulfur compounds, such as H₂S from a gas stream by contacting the gas stream with metal oxides, such as copper oxide, zinc oxide or mixtures of these. It is also known to remove sulfur impurities such as COS by first hydrolyzing COS to H₂S over a hydrolysis catalyst and then removing H₂S by reaction with metal oxides. While these materials are able to remove H₂S and COS, removal of other sulfur impurities such as dimethyl sulfide commonly present in carbon dioxide obtained from a fermenation sources is not easily obtained with prior art materials. More efficient removal of other impurities such as acetaldehyde, alcohols and aromatics such as benzene is also required.

Since many end users of carbon dioxide require the carbon dioxide they use to be substantially free of sulfur compounds, hydrocarbon and other impurities, and because natural sources of carbon dioxide and industrially manufactured carbon dioxide often contain sulfur and hydrocarbon compounds, economic and efficient methods for effecting substantially complete removal of sulfur and hydrocarbon compounds from carbon dioxide gas streams, without concomitantly introducing other impurities into the carbon dioxide, are continuously sought. The present invention provides a simple and efficient method for achieving these objectives.

### SUMMARY OF THE INVENTION

One embodiment of the present invention provides a method for removing impurities from a gas stream comprising passing the gas stream through at least one adsorbent bed selected from the group consisting of an a Y zeolite or its ion exchange form.

Another embodiment of the present invention provides a method for purifying a gas stream comprising passing the gas stream through at least one adsorbent bed selected from the group consisting of a Y zeolite or its ion exchange form.

Another embodiment of the present invention provides a method for removing impurities from a carbon dioxide gas stream comprising passing the gas stream through at least one adsorbent bed selected from the group consisting of a Y zeolite or its ion exchange form.

Yet another embodiment of the present invention provides a system for removing impurities from a gas stream comprising at least one adsorbent bed selected from the group consisting of a Y zeolite or a its ion exchange form.

Yet another embodiment of the present invention provides a system for purifying a gas stream comprising least one adsorbent bed selected from the group consisting of a Y zeolite or its ion exchange form.

Yet another embodiment of the present invention provides a system for removing impurities from a carbon dioxide gas stream comprising at least one adsorbent bed selected from the group consisting of a Y zeolite or its ion exchange form.

The zeolite may be in NaY form. The zeolite in its ion exchange form may be KY or KNaY.

The bed may additionally contain a desiccant for water removal. The bed containing Y zeolite may remove sulfur compounds, such as dimethyl sulfide and oxygenates. The bed additionally contain impregnated activated carbon and/or DAY zeolite to remove aromatics and sulfur compounds.

### BRIEF DESCRIPTION OF THE DRAWINGS

While the specification concludes with claims distinctly pointing the subject matter that Applicants regard as their invention, the invention would be better understood when taken in connection with the accompanying drawings in which:

FIG. 1 is a schematic description of the overall process for purifying and analyzing the carbon dioxide; and

FIG. 2 is a schematic description of purifying carbon dioxide in a carbon dioxide production plant.

### DETAILED DESCRIPTION OF THE INVENTION

The carbon dioxide that is typically produced for industrial operations has a number of impurities present in it. These impurities will often be a concern for many uses of the carbon dioxide, but in the production of products intended for human consumption such as carbonated beverages, and electronic manufacturing the purity of the carbon dioxide is paramount and can influence the taste, quality, and legal compliance of the finished product.

The impure carbon dioxide which can be obtained from any available source of carbon dioxide will typically contain as impurities sulfur compounds such as carbonyl sulfide, hydrogen sulfide, dimethyl sulfide, sulfur dioxide and mercaptans, hydrocarbon impurities such as aldehydes, alcohols, aromatics, propane, ethylene, and other impurities such as water. While carbonyl sulfide and hydrogen sulfide can be removed by prior art materials more efficient materials for the removal of dimethyl sulfide are needed. More efficient materials for the removal of oxygenates are also needed.

This invention specifically deals with the removal of moisture, hydrocarbon impurities such as acetaldehydes, alcohols, acetates and aromatics, and sulfur impurities such as sulfur dioxide, dimethyl sulfide, and mercaptans. Assuming that most of the hydrogen sulfide and carbonyl sulfide have already been removed prior to the beds of this invention trace amounts of these impurities can be removed.

The stream at close to ambient temperatures is sent to an adsorbent bed for the removal of water and other impurities. The adsorbents used will depend on the impurities in the feed. Typically, an adsorbent such as activated alumina (AA), a zeolite such as 4A, 5A, 13X or NaY, or silica gel is used for moisture removal. Additionally, for the purposes of this invention the adsorbent bed will contain a zeolite such as NaY or its ion-exchanged forms such as KY or KNaY for the removal of impurities such as aldehydes, alcohols such as methanol and ethanol, acetates such as methyl and ethyl acetates and some of the trace sulfur compounds such as dimethyl sulfide. For these impurities Y zeolites have significantly higher capacity than other zeolites and non-zeolitic materials. For aromatics such as benzene and toluene other adsorbents such as activated carbon or dealuminated Y (DAY) zeolite are used.

The process of this invention will normally be used in a carbon dioxide production plant. These flow rates can range from 500 to 15,000 std m³/hr. The carbon dioxide will typically be at a pressure in the range of about 12 bara to about 21.5 bara with about 16 to about 19 bara being typical. Temperatures to the adsorber beds can range between 5 and 50° C.

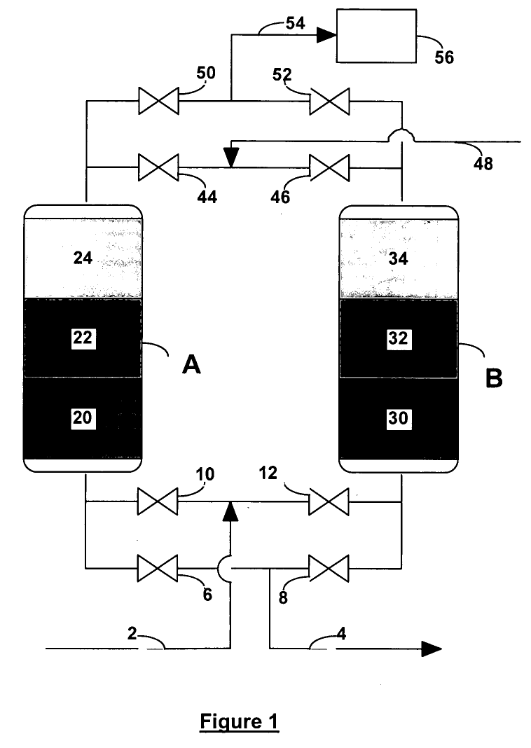

In the broad aspect of the invention, a carbon dioxide gas stream containing impurities is passed through a bed of adsorbent which preferentially adsorbs impurities from the carbon dioxide stream. The adsorption process operates on a TSA (temperature-swing adsorption) cycle. This aspect of the invention can be carried out in the apparatus illustrated in FIG. 1. The adsorption system illustrated in FIG. 1 is depicted as comprising two parallel arranged beds; however, the invention is not limited to a two-bed system. A single bed adsorption system can be used, or the system can comprise more than two parallel-arranged adsorption beds. The number of adsorption beds in the system is not critical to the operation of the invention. In the two bed system, one bed is in the adsorption mode while the other bed is in the regeneration mode.

Adsorbers A and B are identical and each is packed with a bed of adsorbents which adsorb various impurities. For multiple impurities the adsorbents in the bed need to be layered. A typical bed arrangement for feed from the bottom will be a water removal adsorbent in the bottom (layers 20 or 30), followed by a Y zeolite in the middle (layers 22 and 32) for the removal of oxygenates, DMS and SO₂ and an activated carbon/DAY adsorbent (layers 24 and 34) for the removal of aromatics and trace sulfurs in the top. If an impregnated activated carbon (impregnated with sodium or potassium hydroxides and carbonates, or copper oxide or chloride) is used as the last layer it will remove various remaining sulfurs in addition to aromatic impurities. If a non-impregnated activated carbon is used it will remove aromatic impurities as well as mercaptans and some oxygenates. Adsorbents in layers 20 and 30 would typically be activated alumina, silica gel or a zeolite (including zeolite Y) and the adsorbent in layers 22 and 32 will be a NaY zeolite or its ion-exchanged forms. Adsorbents in layers 24 and 34 would normally be either activated carbon or DAY zeolite. However, if removal of trace sulfurs such as COS and H₂S is required impregnated activated carbons containing copper oxide/chloride or sodium and potassium hydroxides/carbonates can be used for the removal of both the aromatics and sulfurs.

In the adsorption system illustrated in FIG. 1, valves 10 and 12 control the flow of feed gas to beds A and B, respectively; valves 6 and 8 control the flow of purge gas and desorbed gas from adsorbers A and B, respectively; valves 44 and 46 control the flow of purge gas to adsorbers A and B, respectively; and valves 50 and 52 control the flow of purified carbon dioxide product from adsorbers A and B, respectively.

The operation of the adsorption system will first be described with bed A in the adsorption mode and bed B in the regeneration mode. In this half of the cycle, valves 8, 10, 46 and 50 are open and valves 6, 12, 44 and 52 are closed. Feed gas enters the adsorption system through line 2, passes through valve 10 and enters adsorber A. As the gas passes through adsorber A, impurities are preferentially adsorbed therefrom. The purified carbon dioxide stream passes through valve 50 and leaves the adsorption system through line 54. In the embodiment illustrated in FIG. 1, the purified carbon dioxide is sent to unit 56 which represents a downstream process.

While high purity carbon dioxide is being produced in adsorber A, the bed of adsorbent in adsorber B is being regenerated. During regeneration, a warm purge gas is introduced into adsorber B through line 48 and open valve 46. It is preferred to use high purity carbon dioxide as the purge gas to avoid contaminating the adsorption beds. The preferred regeneration direction is countercurrent to adsorption direction. Part of the product leaving the system through line 54 can be used as the regeneration purge gas. The warm purge gas passes through bed B, thereby desorbing and sweeping impurities therefrom. The desorbed impurities are removed from the system through open valve 8 and line 4 and vented.

During the course of the adsorption step, the adsorbed gas front in adsorber A progresses toward the outlet end of this unit. When the front reaches a predetermined point in the bed or after a predetermined time, the first half of the cycle is terminated and the second half is begun.

During the second half of the adsorption cycle, adsorber B is put into adsorption service and the bed in adsorber A is regenerated. During this half of the cycle valves 6, 12, 44 and 52 are open and valves 8, 10, 46 and 50 are closed. Feed gas now enters the adsorption system through line 2 and passes through adsorber B through valves 12 and 52 and line 54. Meanwhile the bed in adsorber A is being regenerated. During regeneration of the bed in adsorber A, the warm purge gas passes through the adsorber A via line 48, valve 44, valve 6 and line 4. When the adsorption front in the bed in adsorber B reaches the predetermined point in this bed or after a predetermined time, the second half of the cycle is terminated, and the cycle is repeated. A typical cycle sequence is shown in Table I.

TABLE I
Typical Cycle Sequence for the TSA Process

| Step | Time, Hr. | |
|---|---|---|
| Pressurize Bed A, purify using Bed B | 0.5 | |
| Purify using Bed A, vent Bed B to atmosphere | 0.5 | |
| Purify using Bed A, regenerate Bed B with warm | 8.0 | |
| purge gas | | |
| Purify using Bed A, cool Bed B with cold purge | 15.0 | |
| Pressurize Bed B, purify using Bed A | 0.5 | |
| Purify using Bed B, vent Bed A to atmosphere | 0.5 | |
| Purify using Bed B, regenerate Bed A with warm | 8.0 | |
| purge gas | | |
| Purify using Bed B, cool Bed A with cold purge gas | 15.0 | |
| Total | 48.0 | hr |

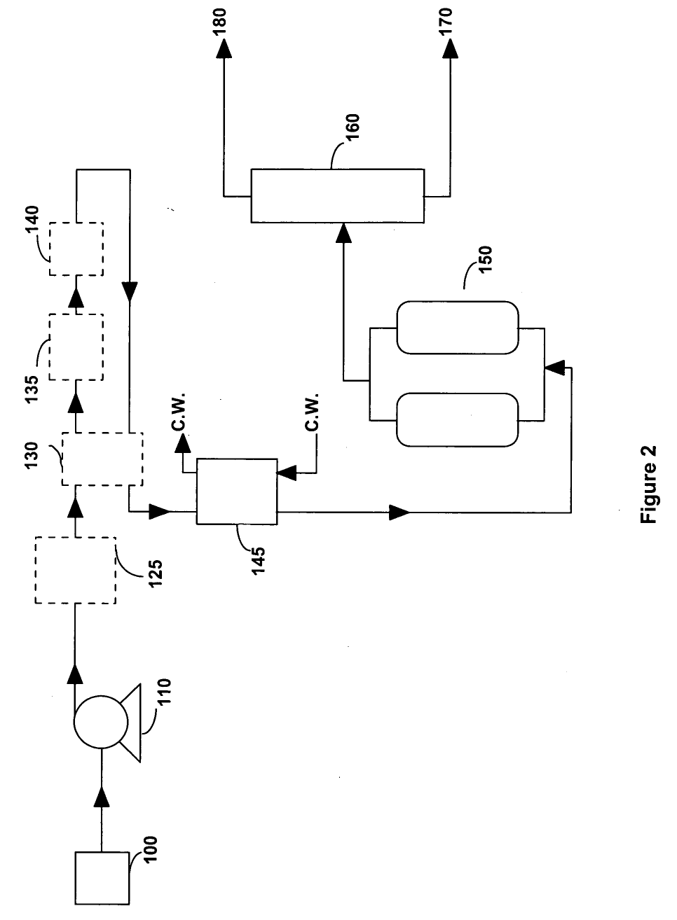

Purification of carbon dioxide in a carbon dioxide production plant using this invention is shown in FIG. 2. Carbon dioxide from source 100 is sent to a compressor 110 to raise its pressure to between 16 and 21 bara and oxygen (not shown) is optionally added to the compressed stream. The stream exiting the final compression stage will be at a temperature between 70° and 95° C. and is sent to an optional sulfur removal unit 125 where sulfur impurities such as hydrogen sulfide, carbonyl sulfide, and mercaptans are removed by reaction with metal oxides, hydroxides or carbonates, or copper exchanged zeolites.

The stream exiting the optional sulfur removal unit 125 is further heated in an optional heat exchanger 130 and optional heater 135 and enters the optional catalytic reactor 140. The catalytic reactor contains supported noble metal catalysts such as palladium or platinum in pelleted or monolith forms. The catalytic reactor operates at a temperature between 150 and 450° C. depending on the impurities in the feed stream. The hydrocarbon impurities are oxidized to water and carbon dioxide in this reactor. The stream exiting reactor 140 is cooled in heat exchanger 130 and further cooled in a water cooled aftercooler 145 to a temperature close to ambient.

The stream exiting aftercooler 145 is sent to an adsorption system 150 for the removal of moisture and other impurities. The details of this adsorption system and the adsorbents contained in the beds were described during the discussion of FIG. 1. The size of the adsorption beds depends on the impurities in feed stream 100 and whether or not reactor 140 is used. As discussed earlier the adsorption beds in adsorption system 150 will have an adsorbent for moisture removal, an adsorbent for the removal of oxygenates such as aldehydes, alcohols, acetates, and DMS, an adsorbent for the remaining sulfur impurities, and aromatics such as toluene and benzene. Purified carbon dioxide exiting adsorption system 150 is liquefied and optionally distilled in unit 160 and sent to product storage via line 170. The non-condensible impurities are removed via line 180.

### EXAMPLE 1

A feed containing 145 ppm methanol in carbon dioxide at a pressure of 14.6 bara and a temperature of 25° C. was passed through a bed containing 0.295 kgs of 3 mm size NaY zeolite at a flow rate of 19.8 std liters/min. No methanol breakthrough (<1 ppm methanol in product) was seen for 170 hours and an equilibrium methanol capacity of 16.4 wt % was obtained.

The same feed was passed through a bed containing 0.345 kgs of 3 mm size activated alumina, commonly used adsorbent for methanol removal from CO₂. The breakthrough time was reduced to less than 63 hours and an equilibrium capacity for methanol of 5.8 wt % was obtained.

Use of NaY zeolite for methanol removal as per the teachings of this invention results in more than 180% increase in methanol removal capacity.

### EXAMPLE 2

A feed containing 50 ppm acetaldehyde in carbon dioxide at a pressure of 14.6 bara and a temperature of 25° C. was passed through different beds containing 0.054 kgs of Alcoa Selexsorb CD, Alcoa Selexsorb CDX and a NaY zeolite, respectively at a flow rate of 19.8 std liters/min. Adsorbent sizes were around 3 mm in all the cases. Selexsorb CD and Selexsorb CDX are the commonly used adsorbents for the removal of acetaldehyde from carbon dioxide. The equilibrium acetaldehyde capacity for Selexsorb CD, Selexsorb CDX and NaY zeolites were 1.8, 4.0 and 9 wt %, respectively. The use of NaY zeolite according to the teachings of this invention leads to significant improvement in removal performance for acetaldehyde.

### EXAMPLE 3

A multilayer bed was assembled according to teachings of this invention. The bed contained a first layer of 0.133 kgs of UOP NaY zeolite in 3 mm size, a second layer of 0.123 kgs of activated carbon impregnated with copper oxide and a third layer of 0.112 kgs of Norit RB4 activated carbon. The internal diameter of the vessel was 0.075 meters.

A feed contaning 100 ppm methanol, 1 ppm carbonyl sulfide, 1 ppm hydrogen sulfide, 2 ppm acetaldehyde and 0.2 ppm benzene was passed through this bed at a flow rate of 20 std liters/min, a pressure of 7 bara and a temperature of 25° C. The test was run for 18 days. No benzene and hydrogen sulfide breakthrough was seen during the test. Methanol, acetaldehyde and carbonyl sulfide did breakthrough after several days though high capacities for each of these impurities was obtained. The methanol and acetaldehyde capacities were similar to those in Examples 1 and 2.

### EXAMPLE 4

A feed containing 2 ppm benzene in carbon dioxide at a pressure of 14.6 bara and a temperature of 20° C. was passed through a bed containing 0.23 kgs of 6×8 mesh DAY zeolite from Degussa at a flow rate of 200 std liters/min. A benzene adsorption capacity of 0.1 wt % was obtained. For the same conditions the benzene adsorption capacity for a bed containing Norit activated carbon was about 0.5 wt %. If carbon dioxide is available for regeneration, activated carbon would be used for benzene removal. However, if air is used for regeneration activated carbon can not be used due to safety reasons and DAY zeolite can be used in this case.

### EXAMPLE 5

A feed containing 3 ppm dimethyl sulfide in carbon dioxide at a pressure of 18 bara and a temperature of 25° C. was passed through different beds containing 0.023 kgs of Alcoa Selexsorb CDX and a NaY zeolite from UOP, respectively at a flow rate of 20 std liters/min. Adsorbent sizes were around 3 mm in all the cases. The equilibrium acetaldehyde capacity for Selexsorb CDX and NaY zeolites were 0.3, and 1.2 wt %, respectively. The use of NaY zeolite according to the teachings of this invention leads to significant improvement in removal performance for dimethyl sulfide.

While the present invention has been described with reference to several embodiments and examples, numerous changes, additions and omissions, as will occur to those skilled in the art, may be made without departing from the spirit and scope of the present invention.

What is claimed is:

1. A method for removing impurities from a gas stream comprising passing the gas stream through at least one adsorbent bed selected from the group consisting of a Y zeolite or its ion exchange form.

2. The method as claimed in claim 1 wherein the gas stream is a carbon dioxide gas stream.

3. The method as claimed in claim 1 wherein the zeolite is selected from the group consisting a NaY, KY and KNaY form.

4. The method of claim 1 wherein the adsorbent bed additionally contains a dessicant for the removal of moisture.

5. The method as claimed in claim 1 wherein the adsorbent bed further contains activated carbon or DAY zeolite for the removal of aromatics and sulfurs.

6. The method as claimed in claim 1 wherein the impurities comprises sulfur compounds.

7. The method of claimed in claim 6 wherein the sulfur compounds comprises dimethyl sulfide.

8. The method as claimed in claim 1 wherein the impurities comprises oxygenates.

9. A method for purifying a gas stream comprising passing the gas stream through at least one adsorbent bed selected from the group consisting of a Y zeolite or its ion exchange form.

10. The method as claimed in claim 9 wherein the gas stream is a carbon dioxide gas stream.

11. The method as claimed in claim 9 wherein the zeolite is selected from the group consisting a NaY, KY and KNaY.

12. The method as claimed in claim 9 where the adsorbent bed additionally contains a dessicant for the removal of moisture.

13. The method as claimed in claim 9 wherein the adsorbent bed further contains activated carbon or DAY zeolite for the removal of aromatics and sulfurs.

14. The method as claimed in claim 9 wherein the adsorbent beds are contained in a single vessel.

15. The method as claimed in claim 9 wherein the impurities comprises sulfur compounds.

16. The method as claimed in claim 15 wherein the sulfur compounds comprise dimethyl sulfide.

17. The method as claimed in claim 9 wherein the impurities comprises oxygenates.

18. A method for removing impurities from a carbon dioxide gas stream comprising passing the gas stream through at least one adsorbent bed selected from the group consisting of a Y zeolite or its ion exchange form.

19. The method as claimed in claim 18 wherein the zeolite is selected from a group comprising NaY, KY and KNaY.

20. The method as claimed in claim 18 where the adsorbent bed additionally contains a dessicant for the removal of moisture.

21. The method as claimed in claim 18 wherein the adsorbent bed further contains activated carbon or DAY zeolite for the removal of aromatics and sulfurs.

22. The method as claimed in claim 18 wherein the impurities comprise sulfur compounds.

23. The method as claimed in claim 18 wherein the impurities comprise oxygenates.

24. A system for removing impurities from a gas stream comprising at least one adsorbent bed selected from the group consisting of a Y zeolite or its ion exchange form.

25. The system as claimed in claim 24 wherein the gas stream is a carbon dioxide gas stream.

26. The system as claimed in claim 24 wherein the zeolite is selected from the group consisting NaY, KY and KNaY.

27. The system as claimed in claim 24 where the adsorbent bed additionally contains a dessicant for the removal of moisture.

28. The system as claimed in claim 24 wherein the adsorbent bed further contains activated carbon or DAY zeolite for the removal of aromatics and sulfurs.

29. A system for purifying a gas stream comprising least one adsorbent bed selected from the group consisting of a Y zeolite or its ion exchange form.

30. The system as claimed in claim 29 wherein the gas stream is a carbon dioxide gas stream.

31. The system as claimed in claim 29 wherein the zeolite is selected from the group consisting of NaY, KY and KNaY.

32. The system as claimed in claim 29 where the adsorbent bed additionally contains a dessicant for the removal of moisture.

33. The system as claimed in claim 29 wherein the adsorbent bed further contains activated carbon or DAY zeolite for the removal of aromatics and sulfurs.

34. The system as claimed in claim 29 wherein the adsorbent beds are contained in a single vessel.

35. A system for removing impurities from a carbon dioxide gas stream comprising at least one adsorbent bed selected from the group consisting of an a Y zeolite or its ion exchange form.

36. The system as claimed in claim 35 wherein the adsorbent beds are contained in a single vessel.

37. The system as claimed in claim 35 wherein the zeolite NaY.
